(19) United States
(12) Patent Application Publication
(10) Pub. No.: US 2026/0340601 A1
(43) Pub. Date: Oct. 29, 2026

(54) SYSTEMS AND METHODS FOR ENHANCED CHECK UTILIZATION FOR PAYMENT

(71) Applicant: JPMORGAN CHASE BANK, N.A., New York, NY (US)

(72) Inventors: Mukesh SHARMA, Wilmington, DE (US); Praveen Chandra NAMALA, Middletown, DE (US); Sagar MANE, Exton, PA (US)

(21) Appl. No.: 19/653,009

(22) Filed: Apr. 20, 2026

Related U.S. Application Data
(60) Provisional application No. 63/793,465, filed on Apr. 23, 2025.

(51) Int. Cl. G06Q 20/04; G06Q 20/02

(52) U.S. Cl. CPC G06Q 20/0425; G06Q 20/023

(57) ABSTRACT

In some embodiments, the techniques described herein relate to a method including: receiving, through an application executed by one or more processors, an image of a check; receiving, by a gateway executed by a financial institution backend and from an application executed by an electronic communication device, the check image from the application; transmitting, by the gateway and from the application, check details and/or the check image to the automated clearing house (“ACH”); receiving, from the ACH by the gateway, a verification that the check has been deposited and of a transfer of an associated amount of money to the gateway; sending, by the gateway and to a payment capture module, the ACH verification; recording, by the payment capture module one or more payment details associated with the check; and updating, by an account update module, an account associated with the application based on the check.

### RELATED APPLICATIONS

This application claims priority to, and the benefit of, U.S. Provisional Patent Application Ser. No. 63/793, 465, filed Apr. 23, 2025, the disclosure of which is hereby incorporated, by reference in its entirety.

### BACKGROUND

### 1. Field of The Invention

Embodiments generally relate to systems and methods for check processing and payments.

### 2. Description of the Related Art

Current payment systems using checks are incapable of processing checks quickly, leading to long delays for money transfers because of the time required to check and verify transactions. Typically, a third-party vendor is required to pick up a payment of a physically mailed check. This process is slow and inefficient as it requires significant time for mail, for a vendor to pick up and scan the check, and then for the vendor to communicate with a financial institution to validate the check payment and then initiate ACH clearing process. Improved techniques will eliminate or reduce overall end-to-end processing time and expense of one or more steps of conventional processes. Improved techniques may be automated and may eliminate human error. Improved techniques will allow a consumer to pay a credit card bill with a submitted check image.

### SUMMARY

Exemplary embodiments provide systems and methods for check processing and payments. According to one embodiment, a method may include receiving, through an application executed by one or more processors, an image of a check; receiving, by a gateway executed by a financial institution backend and from an application executed by an electronic communication device, the check image from the application; transmitting, by the gateway and from the application, check details and/or the check image to the automated clearing house (“ACH”); receiving, from the ACH by the gateway, a verification that the check has been deposited and of a transfer of an associated amount of money to the gateway; sending, by the gateway and to a payment capture module, the ACH verification; recording, by the payment capture module one or more payment details associated with the check; and updating, by an account update module, an account associated with the application based on the check.

Systems and methods may include a computer-implemented method for processing a check payment through an application executed by an electronic communication device and a financial institution backend. Systems and methods may include receiving, through the application, an image of a check; receiving, by a gateway, the image of the check from the application; transmitting, by the gateway, check details and/or the image of the check to an automated clearing house (ACH); receiving, from the ACH, a verification that the check has been deposited and that an associated amount of money has been transferred; sending, by the gateway, the check details and the verification to a payment capture module; recording, by the payment capture module, one or more payment details associated with the check; and updating, by an account update module, an account associated with the application based on the check.

Systems and methods may include that the application requires an account to be logged in through the application in order to submit the image of the check, such that the electronic communication device is verified through the application. Systems and methods may include invoking, by the application, an image capture agent to use a camera of the electronic communication device to capture the image of the check. Systems and methods may include receiving the image of the check includes receiving an image or video of a front side of the check and an image or video of a back side of the check. Systems and methods may include that the application requires the image of the check to be taken within a set amount of time to prevent fraud. Systems and methods may include receiving the image of the check by the gateway includes receiving an application programming interface call having, as one or more parameters, the image of the check, account details, or check details. Systems and methods may include returning, through the gateway to the application, a verification that the payment has been posted.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for processing check payments, in accordance with embodiments.

FIG. 2 is a method for processing check payments, in accordance with embodiments.

FIG. 3 is a block diagram of a computing device for implementing certain embodiments of the present disclosure.

### DETAILED DESCRIPTION

Embodiments generally relate to systems and methods for processing check payments.

Disclosed are systems and methods including receiving, through an application executed by one or more processors, an image of a check; receiving, by a gateway executed by a financial institution backend and from an application executed by an electronic communication device, the check image from the application; transmitting, by the gateway and from the application, check details and/or the check image to the automated clearing house (“ACH”); receiving, from the ACH by the gateway, a verification that the check has been deposited and of a transfer of an associated amount of money to the gateway; sending, by the gateway and to a payment capture module, payment transaction; recording, by the payment capture module one or more payment details associated with the check; and updating, by an account update module, an account associated with the application based on the check. Benefits of disclosed systems and methods include greatly reducing turnaround time and/or reducing or eliminating reliance of vendor processing. Further, human manual review of checks can be eliminated with implementation of one or more embodiments.

Conventional systems include a vendor receiving a physical check in a mailbox, scanning the physical check, and sending separate files for debit and credit to different processing gateways or through different applications or processes of the processing gateway. The gateway then cross validates the separate files for discrepancies and/or missing checks. Only then are scanned images sent to an automated clearing house (“ACH”), and any discrepancies (e.g., missing check data, missing check) take additional days to resolve. This process may take 5-15 business days from a time the check is mailed. This needlessly exposes protected personal information (“PPI”), depends on a mail service which is susceptible to weather or other disasters, and vendor operation. Turnaround time with disclosed systems may be reduced to 1-2 business days and provides an opportunity to provide real-time feedback to a user.

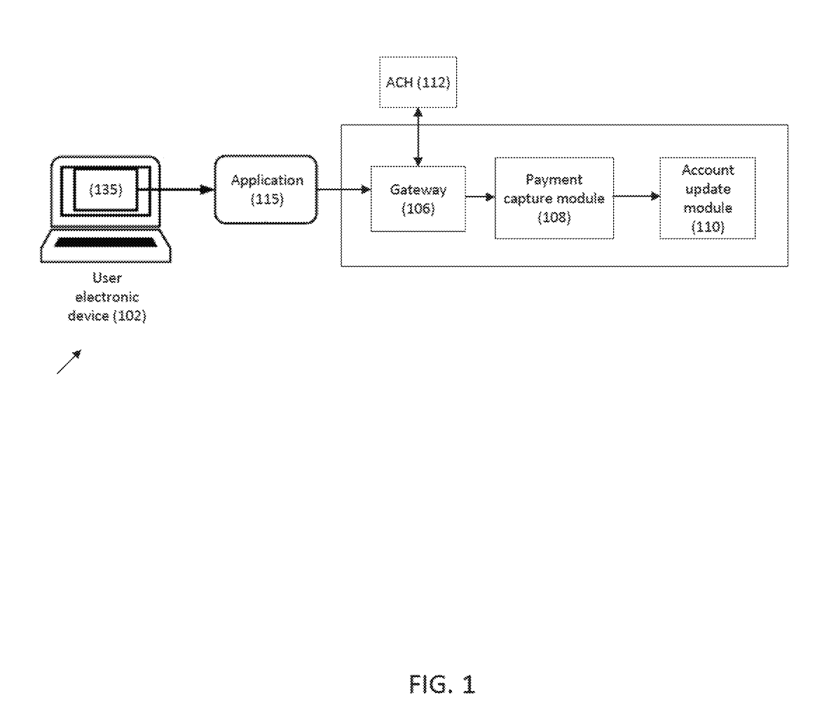

FIG. 1 is a block diagram of a system for check payment processing, in accordance with embodiments.

System 100 includes an electronic communication device 102 executing an application available through a user interface, a financial institution backend 104 comprising a network or computer including a processor executing one or more software modules and a memory for storing data accessible by the one or more software modules and instructions to execute the one or more software modules. The one or more software modules may include a monetary gateway 106, a payment capture module 108, and an account update module 110. One or more databases of the financial institution backend 104 may be accessed and/or include instructions for the one or more software modules.

The application executed by one or more processors of the electronic communication device 102 may capture or receive from an image capture application an image of a check. Electronic communication device 102 may be a laptop, mobile phone, or camera capable of communicating over a wired or wireless interface with a computer network or Internet. The image of the check may be stored on electronic communication device 102 such as in a temporary or permanent database associated with a memory of electronic communication device 102. In some embodiments, an account must be logged in through the application in order to submit the check, such that electronic communication device 102 may be verified or authenticated through the application. In some embodiments, the application may invoke an image capture agent to use a camera of electronic communication device 102 to take a picture of the check. The image capture agent may require an image or video of a front side and an image or video (the same video or a separate video) of a back side of the check. The image capture agent may require the image to be taken in a set amount of time to prevent fraud. The application may use an application programming interface (“API”) call with one or more of the image of the check, account details, check details, as a parameter of the API call to communicate with monetary gateway 106.

The application may be a financial institution application to communicate with financial institution backend 104. The application may open an instance for a user to use the image capture agent and/or connect to a credit card account of the user associated with the financial institution backend 104 (e.g., provided by or managed by).

Gateway 106 may be a monetary gateway that routes one or more of the check image, payment details associated with the check image (e.g., amount, time of upload, recipient name), account details, and/or check details (e.g., routing number, account number, address, payor account name, amount). Monetary gateway 106 may communicate with the application and/or ACH 112, for example, over an internet or through an API gateway or file transfer system. Gateway 106 may return successful payment received to the application 102 as a response to the API call.

Gateway 106 may send the payment transaction and/or ACH verification to payment capture module 108. Payment capture module 108 may record one or more payment details. The record may be stored in a computer network or cloud database. Payment capture module 108 may generate a post payment memorandum.

Account update module 110 may update an account based on the payment received. Account update module 110 may post the payment to the account. Account update module 110 may return, to the payment capture module, a verification of the payment posted as a response to the API call.

ACH 112 may receive the check image and/or check details and generate verification that the check has been deposited and transfer an associated amount of money to gateway 106. In some embodiments, ACH 112 may generate a payment reversal transaction for non-sufficient funds.

As shown in FIG. 1, a system 100 for processing a check payment may include a user electronic device 102, a computer program 115, a gateway 106, a payment capture module 108, an account update module 110, and an automated clearing house (ACH) 112. In some embodiments, the user electronic device 102 may be a laptop computer, mobile phone, camera-enabled device, or other electronic communication device configured to communicate over a wired and/or wireless network. The user electronic device 102 may present a user interface 135 through which a user may access an application associated with a financial institution and initiate submission of a check for payment of an account, such as a credit card account.

In some embodiments, and with continued reference to FIG. 1, the user interface 135 and the computer program 115 may cooperate to guide a user through a check submission workflow executed at the user electronic device 102. The application may require a user to log in before submission of the check, thereby permitting verification or authentication of the user electronic device 102 through the application. The computer program 115 may invoke an image capture agent to use a camera of the user electronic device 102 to capture an image of the check. In some embodiments, the image capture agent may require capture of an image or video of a front side of the check and an image or video of a back side of the check. The image capture agent may further require that the image and/or video be obtained within a set amount of time, which may be used to reduce fraud.

As further shown in FIG. 1, the computer program 115 may communicate captured check information from the user electronic device 102 toward the gateway 106. In some embodiments, the application may use an application programming interface (API) call to transmit one or more parameters including the image of the check, account details, and check details. The check image may be temporarily or permanently stored in a memory associated with the user electronic device 102 before transmission. By acquiring the check image at the user electronic device 102, the disclosed system 100 may reduce or eliminate reliance on conventional workflows in which a physical check is mailed, picked up by a third-party vendor, and later scanned for subsequent processing.

With continued reference to FIG. 1, the gateway 106 may be implemented as a monetary gateway within a financial institution backend and may route one or more of the check image, payment details associated with the check image, account details, and check details for further processing. In some embodiments, the gateway 106 may communicate with the ACH 112 over a network, through an API gateway, or through a file transfer system. The gateway 106 may transmit the check details and/or the check image to the ACH 112 and may receive from the ACH 112 a verification that the check has been deposited and that an associated amount of money has been transferred. The gateway 106 may also return a successful payment indication to the application executing on the user electronic device 102.

As additionally illustrated in FIG. 1, the gateway 106 may provide payment information to the payment capture module 108 after communication with the ACH 112. In some embodiments, the gateway 106 may send a payment transaction and/or ACH verification to the payment capture module 108. The payment capture module 108 may record one or more payment details associated with the check, and the resulting record may be stored in a computer network or cloud database. The payment capture module 108 may further generate a post-payment memorandum corresponding to the submitted payment.

As further shown in FIG. 1, the account update module 110 may be separate from the payment capture module 108 and may update an account based on the payment received from processing of the submitted check. In some embodiments, the account update module 110 may post the payment to the account associated with the application used at the user electronic device 102. The account update module 110 may further return, directly or through the gateway 106, a verification that the payment has been posted, thereby enabling the user interface 135 to present payment status information to the user.

In some embodiments, the arrangement shown in FIG. 1 provides a module-based architecture in which the user electronic device 102 captures check information, the computer program 115 communicates the captured information to the gateway 106, the gateway 106 interfaces with the ACH 112, the payment capture module 108 records payment details, and the account update module 110 posts the payment to the relevant account. This arrangement may reduce turnaround time relative to workflows that depend on mailed checks and third-party vendor scanning, and may further reduce manual handling of check data while enabling automated payment processing through the financial institution backend.

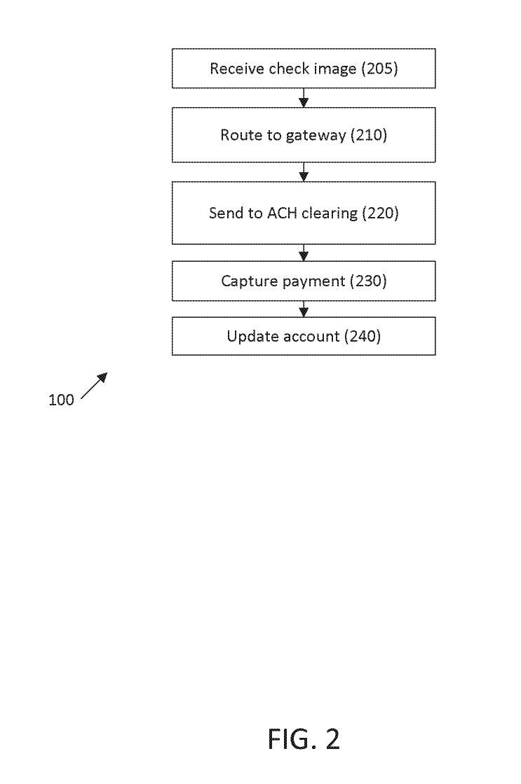

FIG. 2 is a method for check payment processing, in accordance with some embodiments. The method may be stored as a list of instructions stored on a memory that when executed by one or more processors cause the one or more processors to perform the method.

FIG. 2 illustrates a method 200 for processing a check-based payment in accordance with some embodiments. In some embodiments, the method 200 may be implemented by one or more processors executing instructions stored in a memory, such that the instructions cause the one or more processors to perform the operations associated with receiving check information, routing the received information for clearing, capturing payment information, and updating an account responsive to the cleared payment. Although the operations of FIG. 2 are shown in a particular sequence for ease of explanation, it will be understood that the sequence is illustrative only, and that, in some embodiments, one or more operations may be performed in a different order, substantially concurrently, or with one or more intermediate operations not expressly shown in FIG. 2. In some embodiments, one or more communications associated with the method 200 may occur over a wired network, a wireless network, an application programming interface, or another data communication framework suitable for transferring payment-related information between computing components.

At 205, the method 200 may include receiving, through an application executed by one or more processors, an image of a check. In some embodiments, the application may be executed by an electronic communication device, such as a mobile phone, laptop computer, tablet computing device, camera-enabled device, or another user device configured to execute software instructions and communicate with a remote computing environment. The application may be associated with a financial institution and may provide access to an account of a user, such as a credit card account to which the submitted check payment is to be applied. In some embodiments, at 205, the application may open a user session for receiving check information and may present one or more interface elements configured to guide the user through a check submission workflow.

In some embodiments, at 205, the application may require a user to log in before submission of the image of the check, such that the electronic communication device may be verified, authenticated, or otherwise associated with the user through the application. The login process may permit the application to associate the submitted check with a particular account maintained by the financial institution and may provide account details used in subsequent routing, clearing, payment capture, or account update operations. In some embodiments, the image of the check may be captured and stored at the electronic communication device before transmission, and the image may be retained in a temporary memory, a persistent memory, or another storage location accessible to the application.

At 205, the application may invoke an image capture agent to use a camera of the electronic communication device to take a picture of the check. In some embodiments, the image capture agent may control or assist the image acquisition process by prompting the user to position the check within a capture region, to capture a front side of the check, and to capture a back side of the check. The captured content may include a still image, a sequence of images, a video, or another machine-readable representation of the check. In some embodiments, the image capture agent may require an image or video of the front side of the check and an image or video of the back side of the check, with the front-side and back-side content being captured in separate acquisition operations or, in some embodiments, as part of a common video acquisition workflow. The use of front-side and back-side image data may provide additional information for downstream processing of the submitted payment.

In some embodiments, at 205, the image capture agent may require the image or video to be obtained within a set amount of time. The time-based requirement may be used as a fraud prevention mechanism and may be applied, for example, to require capture of front-side and back-side check information within a defined interval associated with a common submission event. In some embodiments, the application may also assemble one or more data elements associated with the submission, such as account details, check details, user information, or other payment-related metadata. At 205, the application may prepare an application programming interface, or API, call that includes one or more parameters corresponding to the image of the check, the account details, the check details, or a combination thereof. The resulting API call may be transmitted from the electronic communication device toward a backend computing environment for further processing.

At 210, the method 200 may include receiving, by a gateway, the API call parameters and/or the check image from the application. In some embodiments, the gateway may be implemented as a monetary gateway within a financial institution backend and may be configured to receive data originating from the application executed by the electronic communication device. The gateway may receive one or more of the check image, payment details associated with the check image, account details, check details, or other information provided as part of the submission event. In some embodiments, at 210, the gateway may normalize, parse, or otherwise prepare the received information for downstream clearing and posting operations. The gateway may further maintain the received information in a format suitable for communication with one or more external or internal processing systems.

In some embodiments, at 210, the gateway may route payment details associated with the submitted check toward an automated clearing house, or ACH, environment for clearing. The routing performed at 210 may be based on one or more check details, such as information identifying a bank associated with an account on which the check is drawn. For example, in some embodiments, the gateway may identify or select an ACH pathway associated with a bank corresponding to the submitted check. The routing performed at 210 may thereby provide a transition from the user-facing application environment to a clearing environment capable of confirming deposit-related activity and associated fund transfer activity.

At 220, the method 200 may include transmitting, by the gateway, check details and/or the check image to the ACH. In some embodiments, the gateway may communicate with the ACH over a data network, through an API gateway, through a file transfer system, or through another communication mechanism suitable for transferring check-related payment information. The transmitted information may include image data corresponding to the check, check details extracted from or associated with the image data, account-related details, or other information used by the ACH to process the submitted payment. In some embodiments, the ACH may evaluate the transmitted information to determine whether the check has been deposited and whether funds corresponding to the check are available for transfer.

In some embodiments, at 220, the gateway may receive from the ACH a verification that the check has been deposited and that an associated amount of money has been transferred. The received verification may be used by the gateway to confirm that the submitted check has advanced through clearing and that the associated payment may proceed within the financial institution backend. In some embodiments, the clearing-related processing at 220 may also be associated with a payment reversal event, such as where non-sufficient funds are identified. Additionally, in some embodiments, the gateway may be configured to return a successful payment received indication to the application in response to the API call, thereby permitting the application to communicate to the user that the submitted check information has been received and processed to a defined stage within the transaction flow.

At 230, the method 200 may include sending, by the gateway, payment details captured by the gateway to a payment capture module. In some embodiments, the gateway may send a payment transaction, an ACH verification, or both to the payment capture module for recording and internal payment administration. The payment capture module may be implemented as a backend module distinct from the gateway and configured to maintain one or more records corresponding to submitted check payments. In some embodiments, the ACH verification processing and the payment capture processing may be two independent processes that can occur in parallel as executed by the gateway or under control of the backend environment. Such an arrangement may permit clearing-related confirmation activity and internal payment-record generation activity to proceed without requiring strict serial execution of all related operations.

In some embodiments, at 230, the payment capture module may record one or more payment details associated with the check. Such payment details may include, by way of example, an amount, a time of upload, a recipient name, routing information, account information, an address, a payor account name, or another data element associated with the submitted payment. The resulting record may be stored in a computer network, a cloud database, or another repository accessible to the financial institution backend. In some embodiments, the payment capture module may further generate a post-payment memorandum corresponding to the payment transaction. The post-payment memorandum may be used to memorialize the payment event within the backend environment and may provide support for later account servicing, reconciliation, or transaction review operations.

At 240, the method 200 may include updating, by an account update module, an account based on the check details and/or the payment received. In some embodiments, the account update module may be separate from the payment capture module and may be configured to post the payment to an account associated with the application, such as a credit card account associated with the logged-in user. The account update module may use the payment details recorded by the payment capture module, the verification received from the ACH, or both, to update account status information maintained by the financial institution backend. The update performed at 240 may include applying the payment to an outstanding balance, modifying account records to reflect receipt of the payment, and maintaining data indicating that the payment has been posted.

In some embodiments, at 240, the account update module may return, through the gateway to the application, a verification that the payment has been posted as a response to the API call or as a subsequent communication associated with the submitted check transaction. The returned verification may permit the application to present payment status information to the user through the user interface of the electronic communication device. Accordingly, FIG. 2 may illustrate an end-to-end method 200 in which check image information is received at 205, routed to a gateway at 210, transmitted for ACH clearing at 220, recorded through payment capture operations at 230, and ultimately applied to an account at 240. In this manner, the method 200 may provide a coordinated processing flow that begins with image capture at a user device and proceeds through clearing, payment recording, and account posting within a financial institution backend.

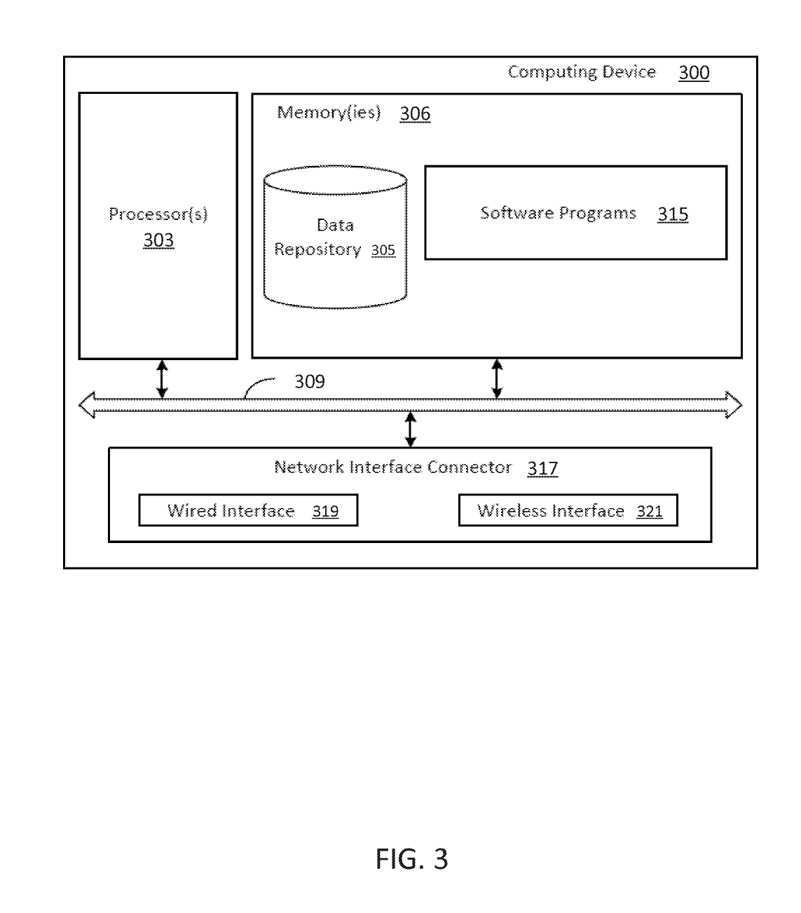

FIG. 3 is a block diagram of a computing device for implementing certain embodiments of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, through an application executed by one or more processors, an image of a check;
receiving, by a gateway executed by a financial institution backend and from an application executed by an electronic communication device, the check image from the application;
transmitting, by the gateway and from the application, check details and/or the check image to the automated clearing house (“ACH”);
receiving, from the ACH by the gateway, a verification that the check has been deposited and of a transfer of an associated amount of money to the gateway;
sending, by the gateway and to a payment capture module, the check details and the ACH verification;
recording, by the payment capture module one or more payment details associated with the check; and
updating, by an account update module, an account associated with the application based on the check.

2. The method of claim 1, wherein:
the application requires an account to be logged in through the application in order to submit the image of the check such that the electronic communication device is verified through the application.

3. The method of claim 1, further comprising:
invoking, by the application, an image capture agent to use a camera of the electronic communication device to capture the image of the check.

4. The method of claim 1, wherein:
receiving the image of the check comprises receiving an image or video of a front side of the check and an image or video of a back side of the check.

5. The method of claim 1, wherein:
the application requires the image of the check to be taken within a set amount of time to prevent fraud.

6. The method of claim 1, wherein:
receiving, by the gateway and from the application executed by the electronic communication device, the check image from the application comprises receiving an application programming interface call having, as one or more parameters, the image of the check, account details, and check details.

7. The method of claim 1, further comprising:
returning, through the gateway to the application, a verification that the payment has been posted.

8. A system comprising:
an electronic communication device comprising one or more processors and a memory storing instructions that, when executed by the one or more processors, cause the electronic communication device to execute an application and receive an image of a check;
a gateway executed by a financial institution backend and configured to receive, from the application executed by the electronic communication device, the image of the check, transmit check details and/or the image of the check to an automated clearing house ("ACH"), and receive, from the ACH, a verification that the check has been deposited and of a transfer of an associated amount of money to the gateway;
a payment capture module configured to receive, from the gateway, the check details and the verification from the ACH and record one or more payment details associated with the check; and
an account update module configured to update an account associated with the application based on the check.

9. The system of claim 8, wherein:
the application requires an account to be logged in through the application in order to submit the image of the check such that the electronic communication device is verified through the application.

10. The system of claim 8, wherein:
the application is configured to invoke an image capture agent to use a camera of the electronic communication device to capture the image of the check.

11. The system of claim 8, wherein:
the image of the check comprises an image or video of a front side of the check and an image or video of a back side of the check.

12. The system of claim 8, wherein:
the application requires the image of the check to be taken within a set amount of time to prevent fraud.

13. The system of claim 8, wherein:
the gateway is configured to receive an application programming interface call having, as one or more parameters, the image of the check, account details, or check details.

14. The system of claim 8, wherein:
the gateway is configured to return, to the application, a verification that payment has been posted.

15. A non-transitory computer-readable medium storing instructions that, when executed by one or more processors, cause a system to:
receive, through an application executed by the one or more processors, an image of a check;
receive, by a gateway executed by a financial institution backend and from an application executed by an electronic communication device, the image of the check from the application;
transmit, by the gateway and from the application, check details and/or the image of the check to an automated clearing house ("ACH");
receive, from the ACH by the gateway, a verification that the check has been deposited and of a transfer of an associated amount of money to the gateway;
send, by the gateway and to a payment capture module, the check details and the verification from the ACH;
record, by the payment capture module, one or more payment details associated with the check; and
update, by an account update module, an account associated with the application based on the check.

16. The non-transitory computer-readable medium of claim 15, wherein:
the instructions further cause the system to require an account to be logged in through the application in order to submit the image of the check such that an electronic communication device executing the application is verified through the application.

17. The non-transitory computer-readable medium of claim 15, wherein:
the instructions further cause the system to invoke an image capture agent to use a camera of an electronic communication device executing the application to capture the image of the check.

18. The non-transitory computer-readable medium of claim 15, wherein:
the instructions further cause the system to receive, as the image of the check, an image or video of a front side of the check and an image or video of a back side of the check.

19. The non-transitory computer-readable medium of claim 15, wherein:
the instructions further cause the system to require the image of the check to be taken within a set amount of time to prevent fraud.

20. The non-transitory computer-readable medium of claim 15, wherein:
the instructions further cause the system to receive, by the gateway, an application programming interface call having, as one or more parameters, the image of the check, account details, or check details.
